(19) United States
(12) Patent Application Publication
(10) Pub. No.: US 2010/0199824 A1
(43) Pub. Date: Aug. 12, 2010

(54) CUTDOWN MACHINE FOR COVERINGS TO FIT ARCHITECTURAL OPENINGS

(76) Inventors: Joseph M. Remmert, Verona, WI (US); Cletis F. Swopes, Janesville, WI (US); Steven J. Neumaier, Sauk City, WI (US)

Correspondence Address: TAYLOR & AUST, P.C., P.O. Box 560, 142. S Main Street, Avilla, IN, 46710, US

(21) Appl. No.: 12/723,166

(22) Filed: Mar. 12, 2010

Related U.S. Application Data
(63) Continuation of application No. PCT/US2008/076132, filed on Sep. 12, 2008.

(51) Int. Cl. B26D 7/06; B26D 7/01; B23D 55/04; B26D 1/46

(52) U.S. Cl. 83/444; 83/788; 83/453; 83/790; 83/467.1; 83/802

(57) ABSTRACT

A cutdown machine for cutting various types of window blinds includes a band saw, and may be incorporated with cutters of other types to provide a cutdown center that is easy to use.

### CROSS REFERENCE TO RELATED APPLICATIONS

This is a continuation of PCT application No. PCT/US2008/076132, entitled “CUTDOWN MACHINE FOR COVERINGS TO FIT ARCHITECTURAL OPENINGS”, filed Sep. 12, 2008, which claimed priority from U.S. provisional patent application Ser. No. 60/971,617, entitled “CUTDOWN MACHINE FOR COVERINGS TO FIT ARCHITECTURAL OPENINGS”, filed Sep. 12, 2007, which are incorporated herein by reference.

### FIELD OF THE INVENTION

The present invention relates to cutting apparatus and methods for trimming window coverings such as window blinds that are trimmed at the time of purchase at retail stores.

### BACKGROUND OF THE INVENTION

Different approaches have evolved to prepare window blinds and other window coverings to be of the dimensions needed to cover a particular window (or other architectural opening) for a specific customer. In one approach, an installer or decorator measures the opening to determine the appropriate dimensions, and a window covering is ordered from the manufacturer or fabricator, where the blind is built to the required dimensions. The completed blind is shipped and installed. While custom manufacturing normally provides a blind of the appropriate size, a disadvantage of this procedure is the time required, whereby several days or even weeks may elapse from initial measuring to final installation. Custom manufacturing also can be expensive.

Another approach involves manufacturing and supplying retail stores with blinds in a number of “stock” sizes for each blind variety, and the customer selects a size that most closely approximates the size of the window to be covered. However, if only a small number of stock sizes are provided, the likelihood of a customer finding a stock size that fits appropriately is reduced. Providing more stock sizes can mitigate fitting difficulties; however, to do so necessarily requires retailers to take on greater inventory and provide more shelf space for the blinds being stocked.

A solution to the foregoing problems has led to a now popular approach, a so-called “size-in-store” system, in which a relatively small number of stock sizes of each blind are provided to the retail outlet. The blinds are designed in a manner such that the headrails, slats (or other window covering materials) and bottom rails can be trimmed at either, and preferably at both ends. “Size-in-store” programs from manufacturers typically include providing the retail store outlet with a cutdown machine designed to cut the particular blinds or other window coverings. Some examples of such cutdown machines are illustrated by U.S. Pat. Nos. 6,178,857 and 6,681,673.

While many different types of cutdown machines exist, certain characteristics are common to many of the machines. Typically, the machines include means for cutting the headrail, the slats (or other window covering material) and the bottom rail of the window covering. In some designs, such that as illustrated in the aforementioned U.S. Pat. No. 6,178,857, different approaches and tools are used to cut the headrail, the slats and/or the bottom rail. In other designs, two or more components are cut by one of the cutting implements. Additionally, known cutdown machines allow for cutting both sides of the window covering, to provide a trimmed window covering having an attractive finished look with the amount that is cut from each end of all components being approximately the same.

Other machines and methods for performing cutdown tasks are disclosed in U.S. Pat. Nos. 5,339,716; 5,037,253; 5,456,149; 4,993,131; 5,072,494 and 5,103,702. However, the machines and methods are not always adequate in providing systems for sizing window shades efficiently and accurately. For example, some of the systems are too complex to be operated by a typical retail salesperson having an average degree of training.

The foregoing problems and concerns are particularly pronounced in the environment of a retail store, such as a home improvement store, in which the responsibility for trimming blinds may rest on a sales associate hired with no background or experience in trimming blinds. While training may be offered by the retail store or by the blind supplier, such training may be minimal, and sales associates achieve different levels of competency. Moreover, it is common for retail stores to have staff turnover, such that sales associates may be asked to trim blinds with little or no training or experience. Retail stores often expect associates from other departments of the store to cover the window blind department, when needed. For example, an associate who normally works in the plumbing department may be asked to assist a consumer with cutting a blind. A cutdown program typically includes multiple product lines requiring several different machines with which to cut them. End stop adjustments and cutting instructions vary from one cutdown machine to another. Untrained, inexperienced or new store associates often have difficulty with correctly setting and operating the machines. When mistakes are made in trimming blinds, it is often necessary to discard a blind and start over, thus impacting the profitability of the program.

Therefore, there is a need for a cutting apparatus for window treatments capable of customizing window treatments efficiently, to fit window dimensions specified by customers. Also, there is a need for a cutting apparatus for cutting a window covering to a specified width, whereby the entire window covering, namely the head rail, the bottom rail and the window covering material are all cut in one setting of the machine, thereby saving time and reducing operator errors. Moreover, it is desirable for the cutting apparatus should produce a final product having a high quality and professionally cut appearance. Further, there is a need to provide a cutdown machine that can be used to cut window coverings of different styles and types. Still further, there is a need for a window covering cutdown machine that is simple to operate.

### SUMMARY OF THE INVENTION

The present invention provides a window covering cutdown machine that can be used for cutting window coverings of various types and of various materials, including but not limited to wood and other natural materials, faux wood, solar shades, vinyl shades, vinyl blinds, cellular blinds, and both vertical and horizontal coverings. The machine also can be used for custom cutting other treatment components for architectural openings, such as, for example and not limitation, drapery rods of various materials including metal, wood and composites. The invention also provides an end stop unit for positioning a product to be cut in a cutdown machine, the end stop unit facilitating cleanout of cutting apparatus in the cutdown machine.

In one aspect of one form thereof, the present invention provides a cutdown machine for cutting window blind products and other treatment products for architectural openings with a band saw, means for positioning and holding a product to be cut and means for causing relative movement between the band saw and the means for holding the product such that an end of the product is cut by the band saw.

In another aspect of another form thereof, the present invention provides a cutdown machine for cutting window blind products and other treatment products for architectural openings with a stationary saw, a tray slidable toward and away from the saw for carrying a product through a cutting region of the saw, means for positioning and holding a product to be cut, and a die cutting unit on an end of the tray for cutting a head rail of a window blind product.

In a further aspect of a further form thereof, the present invention provides an end stop unit for a cutdown machine for cutting window blinds and other treatment for architectural openings with a base, a carriage slidable along the base between a securable operating position and a retracted position, and a fence selectively positionable and securable along the carriage, the fence having an abutment for engaging an end of a product to be cut in the cutdown machine.

Other features and advantages of the invention will become apparent to those skilled in the art upon review of the following detailed description, claims and drawings in which like numerals are used to designate like features

### BRIEF DESCRIPTION OF THE DRAWINGS

FIG. 1 is a perspective view of a window covering cutdown machine in accordance with the present invention;

FIG. 2 is a perspective view of a die cutting station and end stop for the cutdown machine shown in FIG. 1;

FIG. 3 is a perspective view similar to FIG. 2, but showing the end stop in a different position;

FIG. 4 is a cross-sectional view of a portion of the end stop, the view being taken along line 4-4 of FIG. 2;

FIG. 5 is a fragmentary perspective view of a larger portion of the die cutting station shown in FIG. 2;

FIG. 6 is a fragmentary perspective view showing a window covering product positioned for cutting on the cutdown machine shown in the previous drawings, and further showing the die cutting station in a different operational position, generally after a cutting operation in the die cutting station;

FIG. 7 is a fragmentary perspective view similar to FIG. 6, but illustrating an operating position in which the covering material of the window covering product is being cut;

FIG. 8 is a perspective view of another embodiment of the present invention, illustrating another window covering product positioned for cutting;

FIG. 9 is an enlarged fragmentary perspective view of the right and of the cutdown machine as shown in FIG. 8;

FIG. 10 is a fragmentary perspective view of a cutdown machine in accordance with the present invention, illustrating yet another type of window blind positioned for cutting;

FIG. 11 is a fragmentary perspective view of the right end of the machine as illustrated in FIG. 10; and

FIG. 12 is a fragmentary perspective view of yet another window covering product positioned for cutting in a machine of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

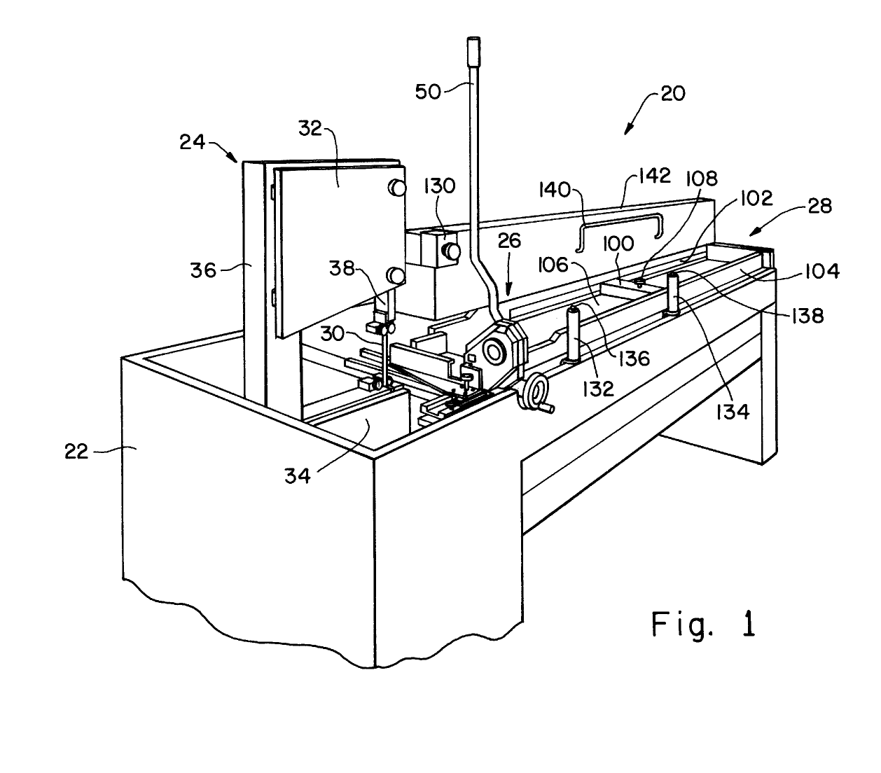

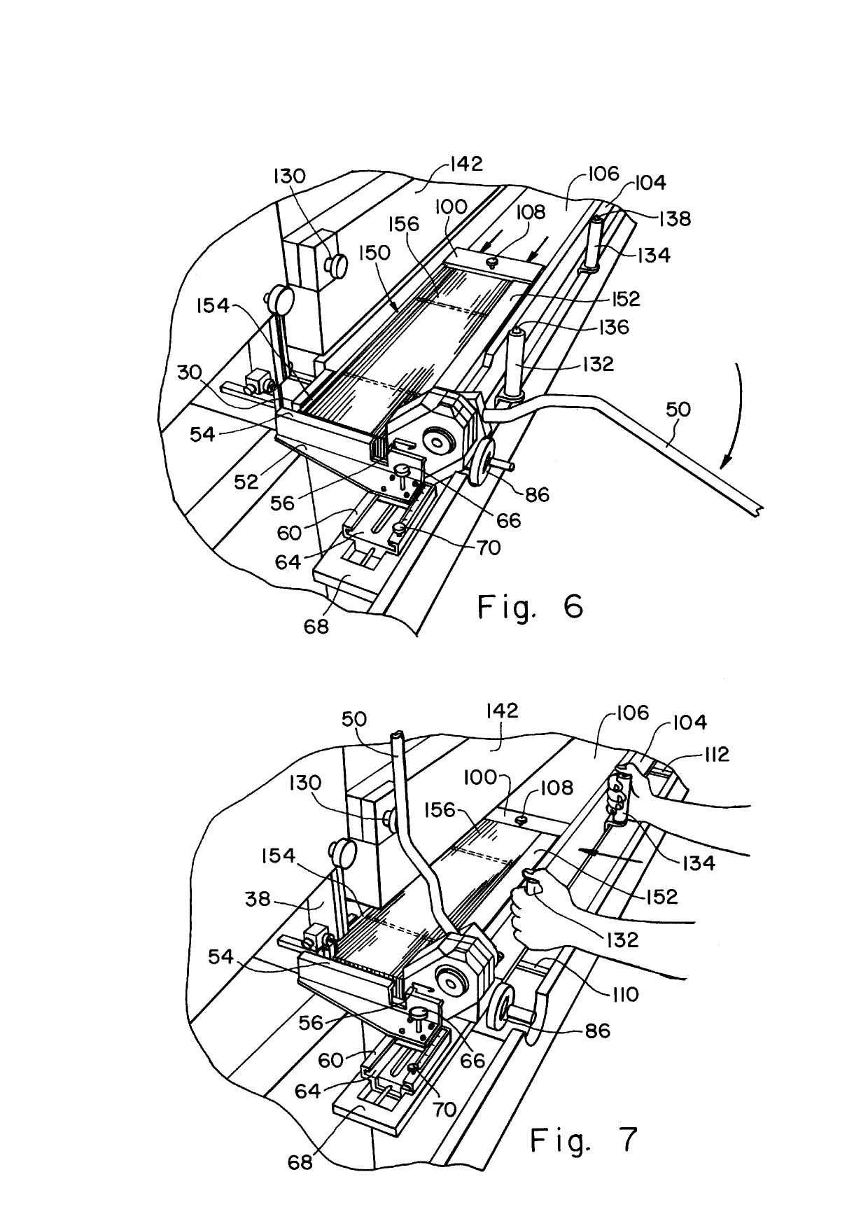

With reference now more specifically to the drawings and to FIG. 1 in particular, a cutdown machine 20 in accordance with the present invention is shown. Cutdown machine 20 includes a support structure 22 having a band saw 24 mounted therein along with a die cutting unit 26 and a movable tray 28. Band saw 24 is positioned substantially at one end of support structure 22, and a movable tray 28 extends along the length of support structure 22. Die cutting unit 26 is positioned at one end of tray 28 substantially adjacent band saw 24. Tray 28 is slidable inwardly and outwardly transverse to its length, with the outward or retracted position shown in FIGS. 1 and 6, and a more inward or advanced position shown in FIG. 7. Die cutting unit 26 is mounted on tray 28 at one end thereof, and moves inwardly and outwardly along with tray 28.

Support structure 22 provides a framework or support for the operating components including band saw 24 and tray 28, with die cutting unit 26 thereon. Support structure 22 can be made of wood, metal or other materials, and may include a combination of such materials. Support structure 22 can be provided to fit within a standard bay opening in so-called big box stores, home improvement centers and the like where size-in-store window covering programs commonly are provided.

Band saw 24 can be a standard, commercially available band saw unit of at least about ⅓ horsepower rating or more. For faster operation, larger motors are desirable, such as for example a ¾ horsepower motor. Band saw 24 includes a continuous band blade 30 of suitable size and saw tooth configuration and count for cutting the materials to be cut thereon. It is expected that universal, multi-material blade types may be used, to provide versatility in the types of materials that can be cut on cutdown machine 20, which may include metals including steel and aluminum, wood and faux wood materials, and synthetic materials such as various plastics. As those skilled in the art will understand, band saw 24 can also have a multi-speed operation through use of a multi-speed motor, or a belt drive system having selectable pulley variations for changing the speed of blade 30. Continuously variable and multiple fixed speed drives are known, and may provide advantages in using cutdown machine 20 on different types of coverings for architectural openings. Band saw 24 further includes an upper compartment 32, a lower compartment 34 and a vertical pillar 36 extending between upper compartment 32 and lower compartment 34. A blade guide 38 extends from upper compartment 32 and is configured for supporting blade 30 as the blade rotates through the vertical space between upper compartment 32 and lower compartment 34 at one side of band saw 24. As those skilled in the art will readily understand, blade 30 rotates along a path between upper compartment 32 and lower compartment 34, which includes a segment through vertical support 36. The various drive, speed control and guide mechanisms discussed above, including a suitable motor, are contained in upper compartment 32, lower compartment 34 and vertical support 36, in known manner.

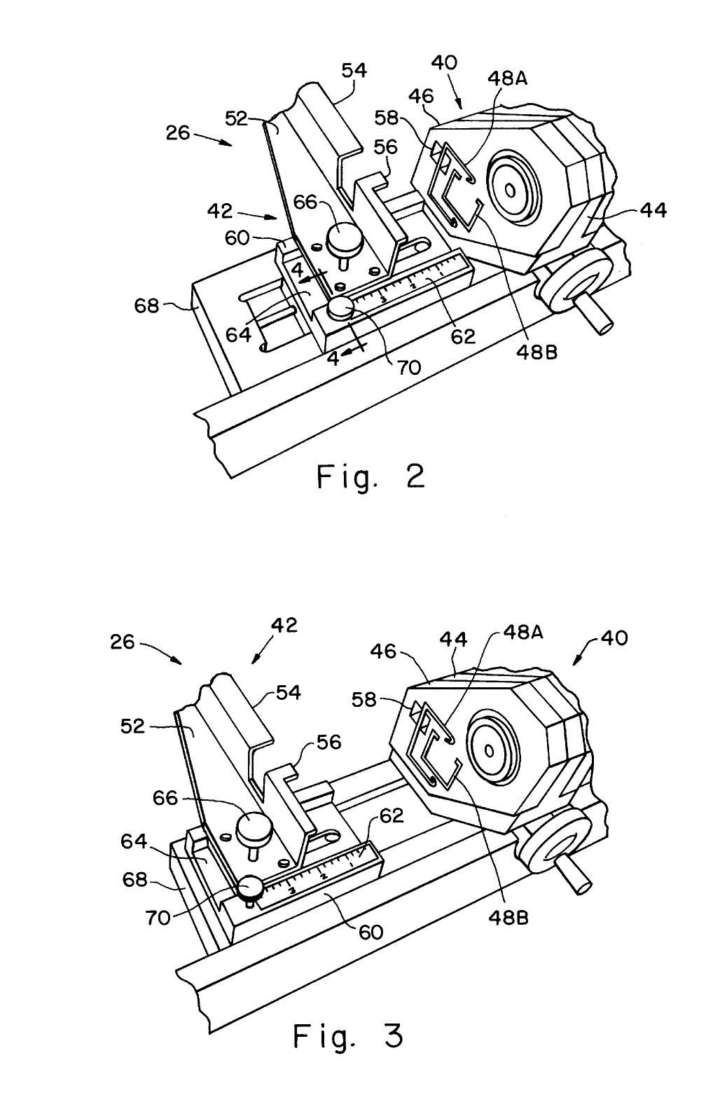

Referring now to FIGS. 2 through 6, die cutting unit 26 will be explained in greater detail. Die cutting unit 26 includes a die cutter 40 and an adjustable end stop unit 42. Die cutter 40 includes first and second dies 44, 46 defining a slot or slots of suitable shape and size to receive a head rail therein. It should be understood that first and second dies 44, 46 can be provided with multiple die slots, for cutting head rails of different types or for cutting blinds of different styles. FIGS. 2 and 3 show two such slots, 48A and 48B, which will be referred to hereinafter collectively and individually as die slots 48 or die slot 48, respectively. A handle 50 (FIG. 5) is operable to move one of the dies relative to the other of the dies to cause a shearing action between the dies, cutting a head rail inserted within slot 48. Die cutters of the type generally described are known for cutting head rails in the industry, and will not be described in greater detail herein.

End stop unit 42 is an adjustably positionable barricade or abutment against which an end of a window covering is placed for alignment of all components prior to cutting. End stop unit 42 positions the window covering product to remove the appropriate width thereof from the various portions thereof in die cutter 40 and band saw 24. Accordingly, end stop unit 42 includes an adjustable fence 52 defining a bottom rail and covering material abutment 54 and a head rail abutment 56. For proper positioning when a very thin slice is to be removed from the window covering, head rail abutment 56 can be advanced into a window 58 in die cutter 40.

Fence 52 is movable along a retractable carriage 60. Carriage 60 can be provided with a measurement scale 62 along an edge of a channel 64 in which fence 52 can be moved. Fence 52 includes a screw-operated locking apparatus 66 which can be tightened against channel 64 to secure a position of fence 52 relative to carriage 60. By positioning fence 52 at a specific measured location along channel 64, by reference to scale 62, a precise amount can be cut from a window covering processed in cutdown machine 20.

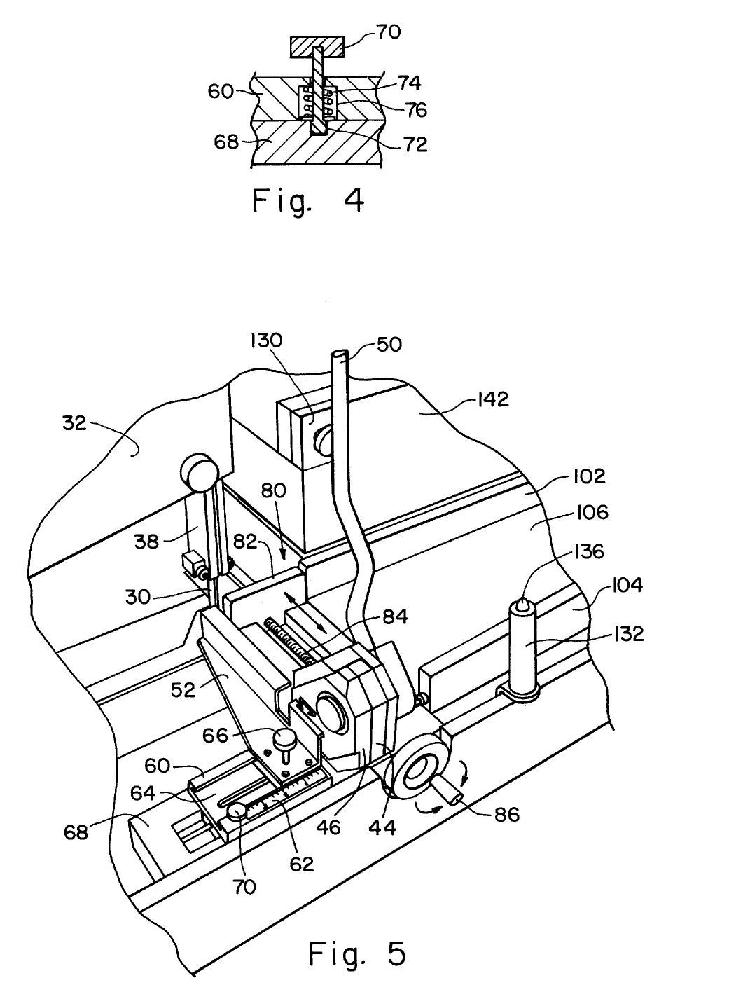

Carriage 60 is retained in a base 68 of die cutting unit 26. Carriage 60 is movable along base 68 between an advanced or operating position and a retracted position. In the operating position, a locating pin 70 is received in a closely fitting hole 72 (FIG. 4) for accurately positioning carriage 60 relative to base 68, and thus also relative to dies 44, 46. A spring 74 surrounding pin 70 and contained within a cavity 76 in carriage 60 biases pin 70 in the direction for locking engagement in hole 72. When locating pin 70 is retracted from receiving hole 72, carriage 60 can be moved away from dies 44, 46 so that a scrap, sheared-off end of a head rail can be removed easily from die cutting unit 26. The retractability of carriage 60 from a fixed location, operating position to the retracted position facilitates cleaning while ensuring that the same amount will be cut from each end of a window covering processed in cutdown machine 20 even if carriage 60 is moved for cleaning a first cut end piece from die cutting unit 26. The relative position of fence 52 to carriage 60 does not change even when carriage 60 is retracted for cleaning. Since the positioning of fence 52 relative to carriage 60 remains the same even as carriage 60 is moved, when carriage 60 is relocated to its fixed location operating position and locked in place by inserting locating pin 70 in closely fitting receiving hole 72, abutments 54 and 56 will have been returned to the previous position relative to dies 44, 46 and band saw 24. Accordingly, after a first end of a window covering has been cut, as will be described in greater detail hereinafter, the scrap material is easily removed by retracting carriage 60, yet fence 52 will be returned to the same position for cutting an opposite end of the covering.

Referring now to FIG. 5, die cutting unit 26 further includes a vise or clamp 80 having a movable jaw 82 between which the bottom rail and window covering material are clamped for cutting, as will be described in greater detail hereinafter. Movable jaw 82 is advanced toward and away from fixed jaw 80 by rotation of a lead screw 84 via a turn wheel or hand crank 86.

Tray 28 defines an elongated bin for receiving and supporting a window covering, and is used for advancing the window covering through band saw 24. Tray 28 includes an adjustable stop 100 (FIG. 1) slidable between tray sides 102 and 104 along the elongated sides of a tray bottom 106. Stop 100 is received in and slides along slots in sides 102 and 104. To fix stop 100 in a selected position, a wedge screw 108 is advanced to wedge stop 100 in position. Stop 100 can be used to facilitate advancing a window covering to be cut against abutments 54 and 56, to ensure that all edge portions of a relatively loosely structured blind are held in proper position against abutments 54 and 56, for straight line cutting, as will be described in greater detail hereinafter.

Tray 28 can be moved away from and toward an operator standing in front of cutdown machine 20. Thus, an end portion of a window covering held in position on tray 28 is moved toward and away from band saw blade 30. Guide rails 110, 112 shown in FIG. 7 are provided for supporting tray 28 and allowing the movement of tray 28 back and forth along guide rails 110, 112. Blade 30 is positioned with respect to die cutter 40 such that an appropriate amount of the bottom rail and shade material are cut off so as to align properly with the cut end of the headrail sized in die cutter 40.

Various convenience and/or safety features are provided. A pull-for-on, push-for-off switch 130 is provided in an easily accessible position to allow for panic stopping if necessary. A vacuum system (not shown) normally will be associated with cutdown machine 20 for removing dust and the like generated during cutting by band saw 24. The vacuum motor can be initiated for operation upon pulling switch 130; however, band saw 24 can be connected electrically so as to not start by closing switch 130 alone. Operating handles 132, 134 are provided for grasping by an operator to move tray 28 inwardly and outwardly for cutting. Button switches 136 and 138 are provided on handles 132, 134, respectively, with both needing to be depressed to activate band saw 24. Alternatively, handles 132, 134 can be positioned on vertical switches whereby downward movement of the handles closes the switches to provide electrical current to band saw 24. In this way, the natural “weight” of an operator's hands will commence operation of band saw 24 as soon as both handles 132, 134 are grasped if and after switch 130 has been closed. Suitable electric circuitry for interconnecting main switch 130, button switches 136, 138 and a motor for powering band saw 24 can be provided.

In the exemplary embodiment of the invention, as shown in FIG. 1, a rack 140 is provided on an upper structure 142 of support structure 22. Rack 140 can be a spring-loaded clamp provided for holding a box or container in which a window covering is shipped and sold when the covering has been removed for cutting in cutdown machine 20. Rack 140 thereby holds the box or other container in an out of the way position while the window covering is being cut to size. Upon completion of cutting, the window covering can be returned to the box for easy carrying and protection as the customer transports the window covering away.

FIGS. 6 and 7 illustrate operation of the cutdown machine to cut a window covering 150 in the nature of a window blind 150 having a head rail 152, a bottom rail 154 and covering material 156 in the nature of blind slats 156 connected to and between head rail 152 and bottom rail 154. As stated previously herein, an advantage of the present invention is that the cutdown machine can be used for cutting various types of window covering materials and components for window coverings including, for example and not limitation, wood and other natural materials, faux wood, solar shades, vinyl shades, vinyl blinds, cellular blinds, metal blinds and both vertical and horizontal coverings. Further, cutdown machine 20 can be used for cutting other components for architectural openings such as, for example, curtain and drapery rods or the like. The procedures for cutting other types of materials and other types of products will be similar to that to be described for cutting blind 150.

The desired finished width for blind 150 is determined, and an appropriate width blind is selected from inventory so that an equal amount can be cut from each end of blind 150 to provide a balanced, centered finished blind construction of the desired final width. The blind is removed from the package or container and is placed in tray 28. The package, box or other container in which blind 150 is distributed and sold can be placed in rack 140 so as to be out of the way as the blind is being cut. The position of end stop unit 42 relative to band saw 24 and die cutting unit 26 is adjusted to establish a fixed position against which blind 150 can be abutted so that an appropriate amount can be cut from a first end of blind 150. Adjustable fence 52 is positioned with respect to measurement scale 62 so that abutments 54 and 56 are properly positioned to establish side edge positions of blind 150 to remove appropriate amounts of the head rail 152 in die cutting unit 26 and of the bottom rail 154 and the covering material 156 in band saw 24.

Head rail 152 is inserted into the appropriate die slot 48 and is advanced therethrough until an end edge thereof encounters abutment 56. Bottom rail 154 and slats 156 are slid along tray 28 and through the general area of vise or clamp 80 until the end edges of the bottom rail and slats encounter abutment 54. Adjustable stop 100 can be used to facilitate movement of blind 150 into the proper position for cutting. Adjustable stop 100 can be slid over bottom 106 and against the end of blind 150 not being cut. Further movement of adjustable stop 100 along and over bottom 106 urges blind 150 toward and into die cutter 40 and through vise 80 until the opposite end of blind 150 engages fence 52. Wedge screw 108 is tightened to secure the position of adjustable stop 100. Blind 150 is then positioned for appropriate removal of an end portion at one end thereof. Hand crank 86 is operated to rotate lead screw 84 and draw movable jaw 82, until bottom rail 154 and slats 156 are tightly clamped in vise 80.

With blind 150 tightly clamped in cutdown machine 20, die cutting unit 26 is operated to remove an end portion of head rail 152. Handle 50 is pulled downwardly (FIG. 6) to cause relative movement between first and second dies 44, 46 causing a sheering action of adjacent surfaces of the dies to cut through head rail 152. Since the removed portion and the remaining portion are tightly held within die slot 48, a clean sheer is achieved. Handle 50 is then returned to its upright position. It should be understood that a lock pin or other securing structure can be used to retain handle 50 in the up or starting position whereby dies 44, 46 are aligned for receiving headrail 152. The shearing operation is then started by first releasing the securing structure. After completing the shearing procedure, when handle 50 is returned to the start position, the securing structure is re-engaged, or can be such as to re-engage automatically.

To cut bottom rail 154 and slats 156, the operator first activates the electrical circuitry in cutdown unit 20 by pulling switch 130. A vacuum system (not shown) is activated to remove dust and debris generated by band saw 24. The operator grasps operating handles 132, 134 and depresses switches 136, 138 or pushes the handles downwardly to activate vertical switches (not shown) to complete electrical circuitry to band saw 24 and commence movement of band blade 30. While continuing to grasp operating handles 132, 134 and thereby continuing to activate the switches associated therewith, the operator then pushes tray 28 away from its position at an outer edge of cutdown machine 20 toward a more inwardly position. Blind and 150 thereby is advanced toward band saw blade 30. As shown in FIGS. 6 and 7, bottom rail 154 and slats 156 are sequentially cut as blind 150 is pushed through band saw 24. It should be understood that appropriate chutes, guides and the like can be provided so that the cut ends of bottom rail 154 and slats 156 will slide away from band saw 24 and into an appropriate waste receptacle therebelow.

Upon completing the first cut through bottom rail 154 and slats 156, the operator withdraws tray 28 back to the starting position near a front edge of cutdown machine 20. Upon releasing operating handles 132, 134, band saw 24 ceases operation.

The cutoff end of head rail 152 is removed from die cutting unit 26 either before or after the end edge portions of bottom rail 154 and slats 156 are removed in band saw 24. Fence 52 is retracted by releasing locating pin 70 from its receiving hole 72 and moving carriage 60 away from die cutting unit 26, thereby more fully exposing the side of die cutting unit 26 from which the head rail piece is removed. This is achieved without moving the position of fence 52 relative to carriage 60. After the severed end of head rail 152 is removed, carriage 60 is returned to its original location, with locating pin 70 received in its closely fitting receiving hole 72. Accordingly, adjustable fence 52 will be in the same location relative to band saw 24 and die cutting unit 26 as when the first end of blind 150 was cut, so that an opposite end of window blind 150 can be abutted there against while cutting, to remove the same amount from the second end as was removed from the first end.

Blind 150 is flipped end for end, and the aforedescribed procedure is repeated for cutting a similar amount from the second end of blind 150. It should be noted that when a particularly short segment of head rail 152 is removed from blind 150, it could be helpful to use the insertion of the second end of head rail 152 to push the cut piece from dies 44 and 46.

It should be understood that vise 80 can be used to secure various other types of structures for subsequent cutting by band saw 24. For example, control rods for blinds, curtain rods and the like can be held in vise 80 and positioned against abutment 54 to establish a cut off amount. Tray 28 can be used to move the structures in and through band saw 24 for cutting.

The present invention further contemplates other structures for a window covering cutdown machine using a band saw and a slidable or movable tray moving the item to be cut into and through the band saw. For example, die cutting unit 26 can be eliminated, and with appropriate clamping the band saw can be used for cutting the entire product, including the head rail, the bottom rail and the covering material therebetween. A second band saw can be provided at the opposite end of tray 28, with one band saw being linearly movable in an axial direction relative to the tray so that a first end of the blind can be cut in one of the band saws and a second end of the blind can be cut in the other of the band saws. During the cutting operation, both saws can be activated and both ends of the blind cut simultaneously. During positioning and set-up, the blind is moved against end stops or abutments at one end, as described previously. At the opposite end, the band saw is moved in a direction parallel to the axis of the blind to position the band saw at an appropriate location for removing a similar amount from the second end of the blind as will be removed from the first end of the blind. As yet a further variation thereof, both saws can be in fixed positions, with tray 28 having a second inner tray therein that is axially movable. The inner tray is positioned at a first extreme lateral position to one side, and the first end of the blind is cut as described previously. Thereafter, the blind can be moved axially in the opposite direction to position the second end of the blind against stops provided at the opposite end in a manner similar to that described previously herein. In arrangements having two band saws, the cutting operation would be facilitated in that the blind does not need to be removed and repositioned for cutting a second end. Once clamped in position, the blind is merely slid first one axial direction and then into the first band saw, and thereafter in an opposite axial direction and into and through the second band saw. Again, the band saw can be used for cutting the entire product, or a second die cutting unit 26 can be provided also at the second end.

Still other variations are contemplated. For example, the die cutting unit can be separate from the tray and not movable therewith, or can be provided as a second station. Further, the band saw can be in a horizontal rather than an upright position, and the product movable vertically upward and downward into and away from the saw. To facilitate movement of the article through the band saw, a motorized drive system such as with a screw drive could be used to advance the tray in an automated, consistent manner through the band saw. Gravity can be used to facilitate movement either inwardly or outwardly by placing the tray on a ramp at a specified angle. The die cutting unit can be provided with a flip up top for removing scrap without moving the end stop. Various types of lever operated quick clamp assemblies can be used in place of the hand wheel and lead screw operated vise 80. Still other variations are contemplated, such as moving the one or two band saws toward and away from the product being cut, rather than moving the product into the band saws.

The use of a band saw in a cutdown machine for window blinds and other treatments for architectural openings provides advantages over known designs using circular saws. A band saw provides a more open cutting region around the band saw blade, including an extended distance between the blade and the vertical support of the band saw. Cutoff ends of the blind are easier to handle and direct in the open structure, even when the cutoff ends are long. Further, the band saw blade is narrow in width and thickness. Accordingly, there is minimal movement of blade against the product being cut, and scorching or burning is minimized. The cutting region is more focused, and residue handling systems can be directed at a specific smaller cutting area of the blade. The particles generated from the thin kerf of a band saw are small and easily vacuumed. Band saws are generally quieter when running under load and not under load.

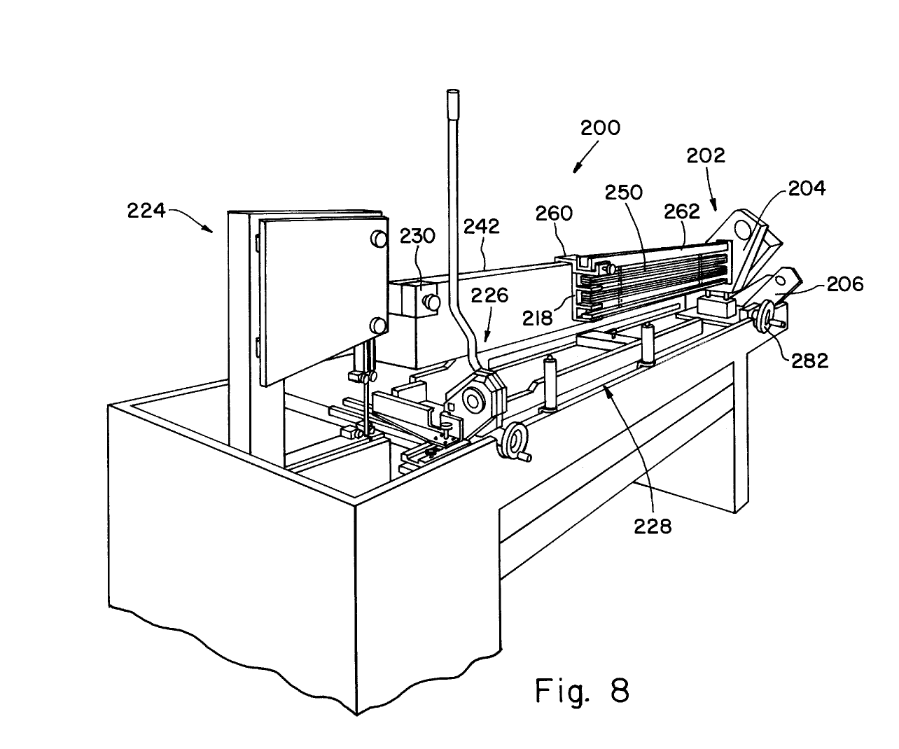

While shown and described thus far herein as a stand-alone unit, the cut down machine of the present invention also can be incorporated into a multi-function unit suitable for cutting window coverings of multiple types. As shown in FIGS. 8-12 a cut down machine 200 includes a band saw 224, a die cutting unit 226 and a movable tray 228 substantially as described previously with respect to band saw 24, die cutting unit 26 and a movable tray 28. Electrical circuitry and a suitable switch 230, similar to switch 130 are provided. Cutdown machine 200 differs from cutdown machine 20 in that a multi-product cutting center 202 is provided for cutting aluminum blinds, vertical blind head rails and slats and cellular blinds at the opposite end of tray 228 from band saw 224 and die cutting unit 226. Cutting center 202 includes an aluminum blind and vertical head rail cutter 204 and a cellular blind and vertical slats cutter 206 operated by a hydraulic or other power unit connected to cutters 204 and 206 by a linkage 208.

Cutter 204 (FIG. 9) includes die cutting positions 210 and 212 for cutting the head rail and bottom rail, respectively of an aluminum blind, and a slats cutting position 214 for cutting the slats of an aluminum blind simultaneously with the cutting of the head rail and bottom rail in die cutting positions 210 and 212, respectively. A die cutting position 216 is provided for receiving and cutting a vertical blind headrail. The general operation of cutter 204 is well known to those skilled in the art, and can follow, for example, the structures and cutting procedures described in U.S. Pat. No. 5,806,394.

An upper structure 242 is provided with one or more slidable rack 218 for holding an aluminum blind 250 in position for cutting in cutter 204. Two such racks 218 are shown. Each rack 218 has opposed finger sets 220 defining holders for snap-in reception and retention of an aluminum blind headrail 252 and bottom rail 254, respectively. Slots 222 between finger sets 220 are provided to hold one or more groups of slats 256. Racks 218 are slidable along upper structure 242 to advance ends of headrail 252, bottom rail 254 and slats 256 into, and to withdraw head rail 252, bottom rail 254 and slats 256 from die cutting positions 210, 212 and slats cutting position 214, respectively.

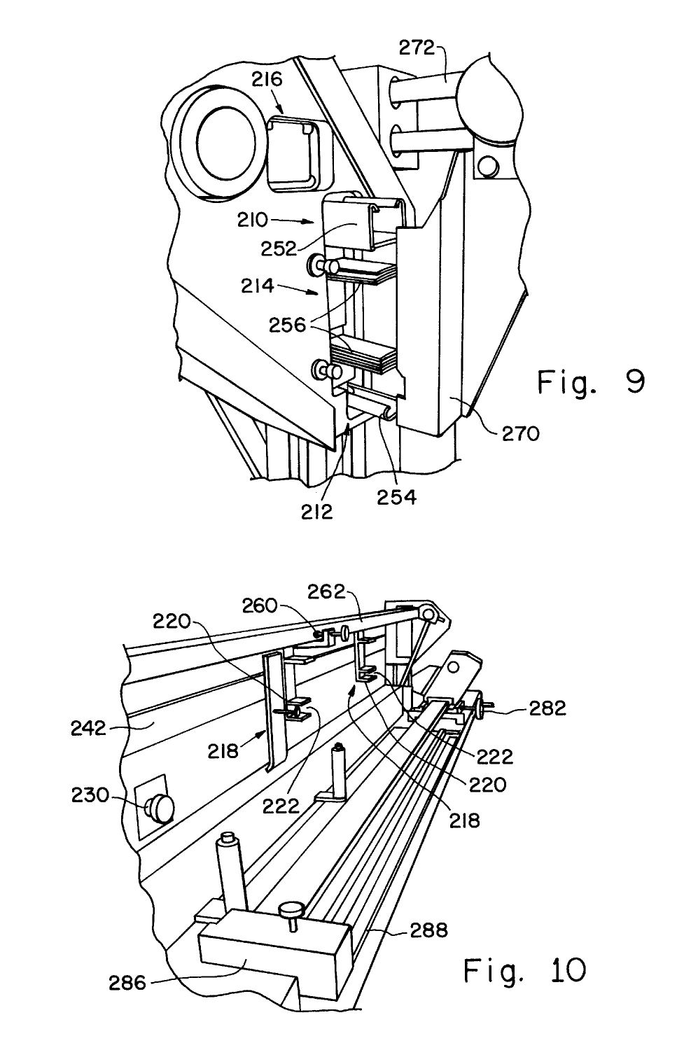

A vertical head rail clamp 260 (FIG. 10) is provided along upper structure 242 to hold and align a vertical blind head rail 262 with vertical head rail die cutting position 216. Head rail clamp 260 also can be slidable along upper structure 242 to advance vertical head rail 262 into and withdraw head rail 262 from die cutting position 216.

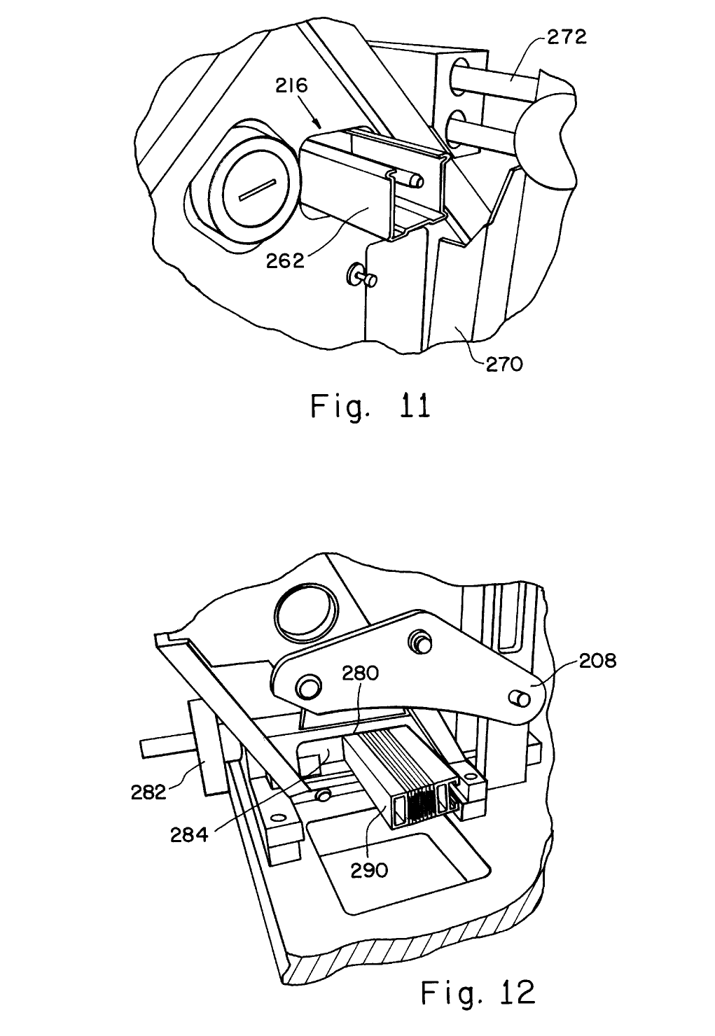

An end stop 270 (FIGS. 9 and 11) adjustably carried on a track 272 can be used to establish the amount to be cut from a blind in cutter 204. The ends to be cut from head rail 252, bottom rail 254 and slats 256 are butted against end stop 270 (FIG. 20), which is adjustable positioned on track 272 to define the amount of head rail 252, bottom rail 254 and slats 256 projecting beyond die cutting positions 210, 212 and slats cutting position 214. Alternatively and/or cooperatively, adjustable scales and pointers can be provided on upper structure 242, racks 218 and head rail clamp 260, or otherwise on cut down machine 200 to establish accurate lengths of a blind remaining after a cut is performed in cutter 204.

Cutter 206 (FIG. 12) defines a throat 280 and includes a clamp 282 for receiving and holding a cellular blind or a stack of vertical blind slats therein to be cut by an advancing knife 284 at throat 280. An adjustable stop 286 (FIG. 10) is slidable along a table 288 beneath tray 228 to establish an end position for a cellular blind 290 or a stack of vertical slats to be cut in cutter 206. All components of the cellular blind, the stack of vertical slats or other window blind products of suitable materials are positioned in throat 280 and secured by clamp 282 for cutting by knife 284. The general operation of cutter of the type of cutter 206 is well known to those skilled in the art, and can follow, for example and not limitation, the structures and cutting procedures described in U.S. Pat. Nos. 6,435,066 and 6,681,673.

Thus, the present invention can provide a structure for the incorporation of multiple cutting units for cutting window coverings of various types. Some products can be cut using band saw 224 and die cutting unit 226 at one end of cutdown machine 200 and other types of products can be cut in multiproduct cutting center 202 at an opposite end of cutdown machine 200. Accordingly, a compact window treatment cutting center is provided in the space of a single bay of a big-box store, capable of cutting window treatments and coverings for other architectural openings of many types.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A cut down machine for cutting window blind products and other treatment products for architectural openings, said cutdown machine comprising:
a band saw;
means for positioning and holding a product to be cut; and
means for causing relative movement between the band saw and the means for holding the product, such that an end of the product is cut by the band saw.

2. The cut down machine of claim 1, said band saw being in a fixed position, and said means for causing relative movement gained configured for causing movement of said means for positioning and holding a product.

3. The cutdown machine of claim 2, including a tray slidable toward and away from said band saw and a die cutter on an end of said tray for cutting a head rail.

4. The cutdown machine of claim 3, including a multi-product cutting station disposed at an opposite end of said tray from said die cutter.

5. The cut down machine of claim 1, including a slidable tray for positioning and holding a product to be cut, a die cutter at one end of said tray adjacent said band saw for cutting window blinds of at least one type, and a multi-product cutting center at an opposite end of said tray for cutting blinds of at least second and third types.

6. The cutdown machine of claim 1, including a die cutter and an end stop unit having abutments for positioning a product relative to said die cutter and relative to said band saw.

7. The cutdown machine of claim 6, said die cutter defining a window, and said end stop unit having a head rail abutment slidable into said window.

8. The cutdown machine of claim 6, said end stop unit including a fence selectively positionable along a carriage, and said carriage being slidable along a base.

9. The cutdown machine of claim 8, said carriage including a scale and said fence being slidable on said carriage and having locking apparatus for securing a selected location of said fence with respect to said scale.

10. The cutdown machine of claim 8, said base defining a hole, and said carriage having a retractable pin received in said hole.

11. A cut down machine for cutting window blind products and other treatment products for architectural openings, said cutdown machine comprising:
a stationary saw;
a tray slidable toward and away from said saw for carrying a product through a cutting region of said saw;
means for positioning and holding a product to be cut; and
a die cutting unit on an end of said tray for cutting a head rail of a window blind product.

12. The cutdown machine of claim 11, including a multi-product cutting center at an end of said tray opposite said die cutting unit.

13. The cutdown machine of claim 11, including an end stop unit having abutments for positioning a product relative to said die cutter and relative to said saw.

14. The cutdown machine of claim 13, said die cutter defining a window, and said end stop unit having a head rail abutment slidable into said window.

15. The cutdown machine of claim 13, said end stop unit including a fence selectively positionable along a carriage, and said carriage being slidable along a base.

16. The cutdown machine of claim 15, said fence being slidable on said carriage and having locking apparatus for securing a selected location of said fence with respect to said carriage.

17. The cutdown machine of claim 15, said base defining a hole, and said carriage having a retractable pin received in said hole.

18. An end stop unit for a cutdown machine for cutting window blinds and other treatments for architectural openings, said end stop unit comprising:
a base;
a carriage slidable along said base between a securable operating position and a retracted position; and
a fence selectively positionable and securable along said carriage, said fence having an abutment for engaging an end of a product to be cut in the cutdown machine.

19. The end stop unit of claim 18, said base defining a hole, and said carriage having a retractable pin received in said hole.

20. The end stop of claim 18, said fence having first and second abutments for engage different parts of a product to be cut in the cutdown machine.
